(19) United States
(12) Patent Application Publication
(10) Pub. No.: US 2020/0410049 A1
(43) Pub. Date: Dec. 31, 2020

(54) PERSONALIZING ONLINE FEED PRESENTATION USING MACHINE LEARNING

(71) Applicant: Microsoft Technology Licensing, LLC, Redmond, WA (US)

(72) Inventors: Vivek Yogesh Tripathi, San Jose, CA (US); Timothy Paul Jurka, Redwood City, CA (US); Ankan Saha, San Francisco, CA (US); Collin Dang Yen, Saratoga, CA (US)

(21) Appl. No.: 16/457,713

(22) Filed: Jun. 28, 2019

(51) Int. Cl. G06F 17/24; H04L 29/08; G06F 17/21; G06N 20/00

(52) U.S. Cl. CPC G06F 17/248; G06N 20/00; G06F 17/212; H04L 67/306

(57) ABSTRACT

Techniques for personalizing a user experience for a user of an online service using machine learning are disclosed herein. In some embodiments, a computer system detects a first request by a first computing device of a first user to access content of an online service, identifies at least one content item to display based on the first request, and selects a first presentation template from amongst a plurality of presentation templates based on the at least one content item and an identification of the first user. In some example embodiments, the plurality of presentation templates is stored in a database of the online service, and each one of the plurality of presentation templates is distinct from one another and defines a corresponding manner in which to display the at least one content item.

### TECHNICAL FIELD

The present application relates generally to systems and methods, and computer program products for personalizing a user experience for a user of an online service, such as an online feed presentation, using machine learning.

### BACKGROUND

Online services present content to users. When users view content, their response, such as whether to engage or scroll past, is motivated not only by the content itself, but also by the way it is presented to the users. However, the manner in which a particular content item is presented is not personalized for each user. For two different users, the same content item (e.g., the same news article, the same job posting, the same profile status update) is presented in the same way for both users, despite the fact the one user may be more responsive to the content item being presented in one way, while the other user may be more responsive to the content item being presented in another way. This lack of personalization with respect to the manner in which content is presented to users results in poor engagement of the users with the online service. Furthermore, the lack of personalization also results in users spending a longer time in their search or navigation for content, leading to excessive consumption of electronic resources, such as a wasteful use of processing power and computational expense associated with generating and displaying irrelevant content, and a wasteful use of network bandwidth associated with navigating through the irrelevant content.

Additionally, the lack of personalization also extends to the technical characteristics or environment in which the computing device of the user is accessing the online service. For example, personal aspects such as the device type of the user's computing device, the type of operating system of the user's computing device, the wireless connection strength of the user's computing device, the battery charge level of the user's computing device, and the display screen size of the user's computing device all affect the functioning of the computing device in the presentation of the content, but are not currently addressed in determining the manner in which the content is presented. As a result, the functioning of the computing device is negatively affected. Other technical problems may arise as well.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a client-server system, in accordance with an example embodiment.

FIG. 2 is a block diagram showing the functional components of a social networking service within a networked system, in accordance with an example embodiment.

FIG. 3 is a block diagram illustrating components of a user experience system, in accordance with an example embodiment.

FIG. 4 illustrates a table of presentation templates stored in a database, in accordance with an example embodiment.

FIG. 5 illustrates a graphical user interface (GUI) in which content items are displayed using a presentation template, in accordance with an example embodiment.

FIG. 6 illustrates a GUI in which content items are displayed using another presentation template, in accordance with an example embodiment.

FIG. 7 is a flowchart illustrating a method of personalizing a user experience for a user of an online service, in accordance with an example embodiment.

FIG. 8 is a flowchart illustrating another method of personalizing a user experience for a user of an online service.

FIG. 9 is a block diagram illustrating a mobile device, in accordance with some example embodiments.

FIG. 10 is a block diagram of an example computer system on which methodologies described herein may be executed, in accordance with an example embodiment.

### DETAILED DESCRIPTION

I. Overview

Example methods and systems of personalizing a user experience for a user of an online service, such as an online feed presentation, are disclosed. In the following description, for purposes of explanation, numerous specific details are set forth in order to provide a thorough understanding of example embodiments. It will be evident, however, to one skilled in the art that the present embodiments may be practiced without these specific details.

Some or all of the above problems may be addressed by one or more example embodiments disclosed herein. In some example embodiments, a specially-configured computer system identifies a content item to display to a user on a computing device based on a request by the computing device to access content of an online service, and then selects a presentation template from amongst a plurality of different presentation templates based on the content item and an identification of the user. Each presentation template defines a corresponding manner in which to display the content item. The computer system then causes the content item to be displayed on the computing device of the user in the corresponding manner of the selected presentation template. As a result, the manner in which the content item is displayed to the user is personalized for the user, thereby reducing excessive consumption of electronic resources associated with a lack of personalization.

Additionally, the selection of the presentation template, and thus the determination of the manner in which the content item is to be displayed to the user, is further based on one or more technical characteristics of the computing device, such as the device type of the user's computing device, the type of operating system of the user's computing device, the wireless connection strength of the user's computing device, the battery charge level of the user's computing device, and the display screen size of the user's computing device all affect the functioning of the computing device in the presentation of the content. As a result, the functioning of the computing device is improved, since the presentation of the content item is tailored for the specific technical characteristics of the computing device.

The implementation of the features disclosed herein involves a non-generic, unconventional, and non-routine operation or combination of operations. By applying one or more of the solutions disclosed herein, some technical effects of the system and method of the present disclosure are to reduce excessive consumption of electronic resources associated with a lack of personalization and to configure the presentation of the content item specifically for the technical characteristics of the computing device. As a result, the functioning of the computer system is improved. Other technical effects will be apparent from this disclosure as well.

II. Detailed Example Embodiments

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

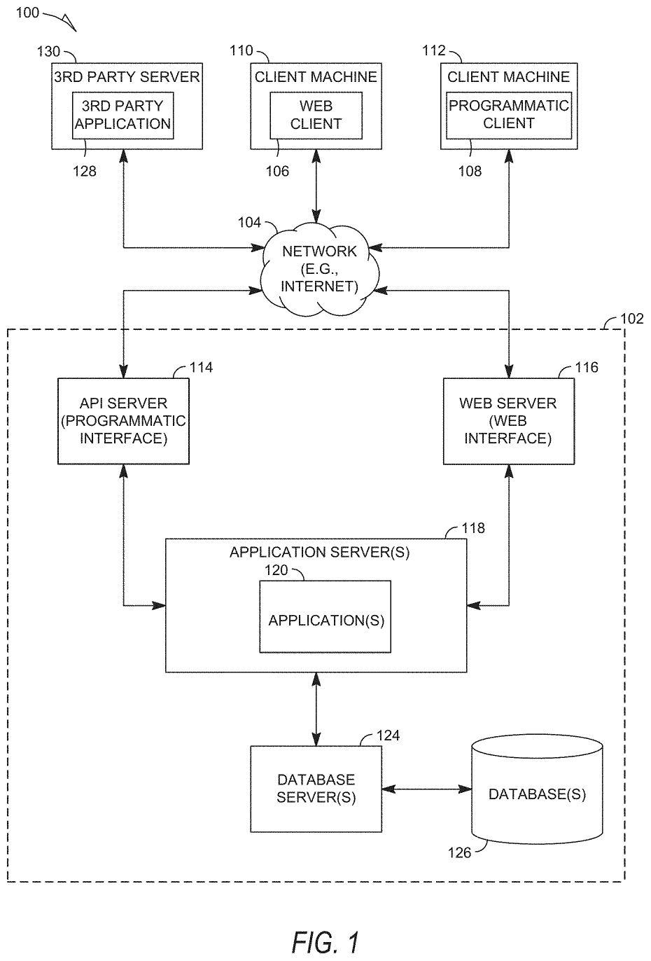

FIG. 1 is a block diagram illustrating a client-server system 100, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third-party application 128, executing on a third-party server machine 130, as having programmatic access to the networked system 102 via the programmatic interface provided by the API server 114. For example, the third-party application 128 may, utilizing information retrieved from the networked system 102, support one or more features or functions on a website hosted by the third-party. The third-party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

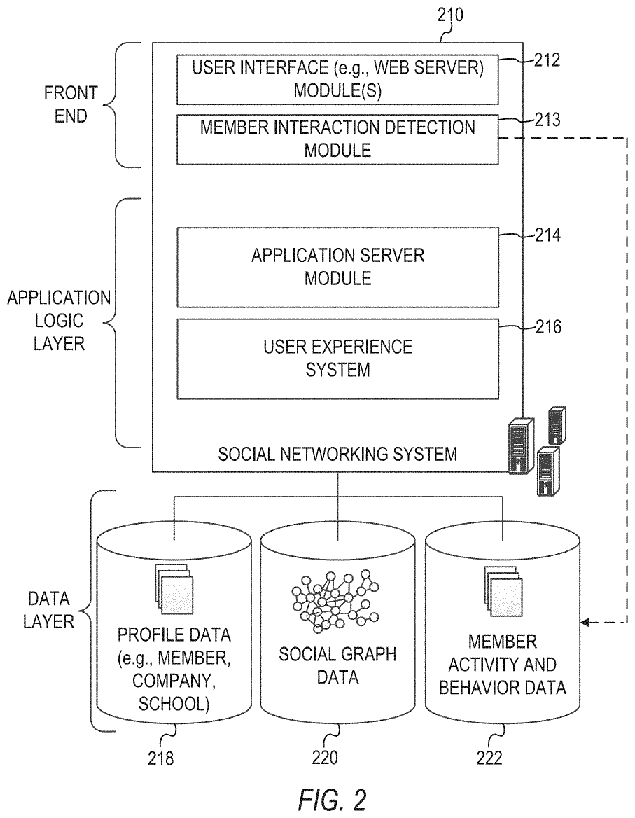

In some embodiments, the networked system 102 may comprise functional components of a social networking service. FIG. 2 is a block diagram showing the functional components of a social networking system 210, including a data processing module referred to herein as a user experience system 216, for use in social networking system 210, consistent with some embodiments of the present disclosure. In some embodiments, the user experience system 216 resides on application server(s) 118 in FIG. 1. However, it is contemplated that other configurations are also within the scope of the present disclosure.

As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transfer Protocol (HTTP) requests, or other web-based, application programming interface (API) requests. In addition, a member interaction detection module 213 may be provided to detect various interactions that members have with different applications, services and content presented. As shown in FIG. 2, upon detecting a particular interaction, the member interaction detection module 213 logs the interaction, including the type of interaction and any meta-data relating to the interaction, in a member activity and behavior database 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service. In some example embodiments, the application logic layer includes the user experience system 216.

As shown in FIG. 2, a data layer may include several databases, such as a database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 218. Similarly, when a representative of an organization initially registers the organization with the social networking service, the representative may be prompted to provide certain information about the organization. This information may be stored, for example, in the database 218, or another database (not shown). In some example embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources and made part of a company's profile.

Once registered, a member may invite other members, or be invited by other members, to connect via the social networking service. A “connection” may require or indicate a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with database 220.

As members interact with the various applications, services, and content made available via the social networking system 210, the members' interactions and behavior (e.g., content viewed, links or buttons selected, messages responded to, etc.) may be tracked and information concerning the member's activities and behavior may be logged or stored, for example, as indicated in FIG. 2 by the database 222. This logged activity information may then be used by the user experience system 216. The members' interactions and behavior may also be tracked, stored, and used by the user experience system 216 residing on a client device, such as within a browser of the client device, as will be discussed in further detail below.

In some embodiments, databases 218, 220, and 222 may be incorporated into database(s) 126 in FIG. 1. However, other configurations are also within the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more navigation recommendations. Such applications may be browser-based applications or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third-party applications and services.

Although the user experience system 216 is referred to herein as being used in the context of a social networking service, it is contemplated that it may also be employed in the context of any website or online services. Additionally, although features of the present disclosure can be used or presented in the context of a web page, it is contemplated that any user interface view (e.g., a user interface on a mobile device or on desktop software) is within the scope of the present disclosure.

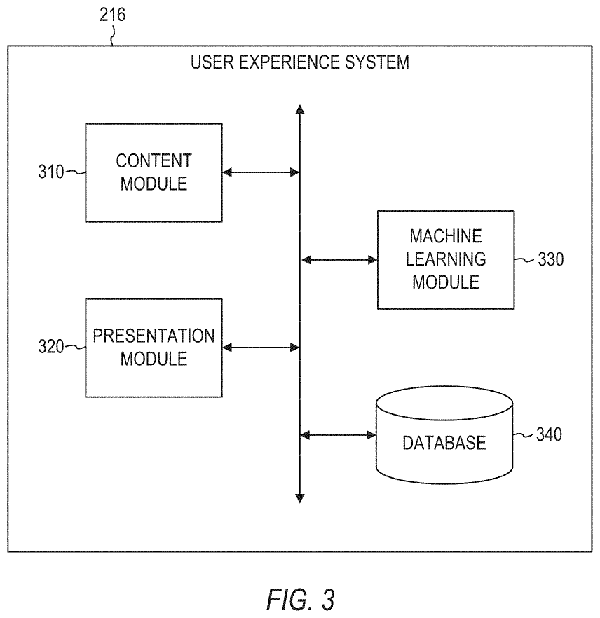

FIG. 3 is a block diagram illustrating components of a user experience system 216, in accordance with an example embodiment. When users view a content item, such as an update on a social networking service feed, their response—whether to engage, scroll past, or exit—is motivated not only by the content of the content item (or its associated social components), but also by the way it is presented to the user. The user experience system 216 is configured to use artificial intelligence to personalize the manner in which the content item is presented.

In some embodiments, the user experience system 216 comprises any combination of one or more of a content module 310, a presentation module 320, a machine learning module 330, and one or more database(s) 340. The content module 310, the presentation module 320, the machine learning module 330, and the database(s) 340 can reside on a computer system, or other machine, having a memory and at least one processor (not shown). In some embodiments, the content module 310, the presentation module 320, the machine learning module 330, and the database(s) 340 can be incorporated into the application server(s) 118 in FIG. 1. In some example embodiments, the database(s) 340 is incorporated into database(s) 126 in FIG. 1 and can include any combination of one or more of databases 218, 220, and 222 in FIG. 2. However, it is contemplated that other configurations of the content module 310, the presentation module 320, the machine learning module 330, and the database(s) 340, are also within the scope of the present disclosure.

In some example embodiments, one or more of the content module 310, the presentation module 320, and the machine learning module 330 is configured to provide a variety of user interface functionality, such as generating user interfaces, interactively presenting user interfaces to the user, receiving information from the user (e.g., interactions with user interfaces), and so on. Presenting information to the user can include causing presentation of information to the user (e.g., communicating information to a device with instructions to present the information to the user). Information may be presented using a variety of means including visually displaying information and using other device outputs (e.g., audio, tactile, and so forth). Similarly, information may be received via a variety of means including alphanumeric input or other device input (e.g., one or more touch screen, camera, tactile sensors, light sensors, infrared sensors, biometric sensors, microphone, gyroscope, accelerometer, other sensors, and so forth). In some example embodiments, one or more of the content module 310, the presentation module 320, and the machine learning module 330 is configured to receive user input. For example, one or more of the content module 310, the presentation module 320, and the machine learning module 330 can present one or more GUI elements (e.g., drop-down menu, selectable buttons, text field) with which a user can submit input.

In some example embodiments, one or more of the content module 310, the presentation module 320, and the machine learning module 330 is configured to perform various communication functions to facilitate the functionality described herein, such as by communicating with the social networking system 210 via the network 104 using a wired or wireless connection. Any combination of one or more of the content module 310, the presentation module 320, and the machine learning module 330 may also provide various web services or functions, such as retrieving information from the third party servers 130 and the social networking system 210. Information retrieved by the any of the content module 310, the presentation module 320, and the machine learning module 330 may include profile data corresponding to users and members of the social networking service of the social networking system 210.

Additionally, any combination of one or more of the content module 310, the presentation module 320, and the machine learning module 330 can provide various data functionality, such as exchanging information with database(s) 340 or servers. For example, any of the content module 310, the presentation module 320, and the machine learning module 330 can access member profiles that include profile data from the database(s) 340, as well as extract attributes and/or characteristics from the profile data of member profiles. Furthermore, the one or more of the content module 310, the presentation module 320, and the machine learning module 330 can access social graph data and member activity and behavior data from database(s) 340, as well as exchange information with third party servers 130, client machines 110, 112, and other sources of information.

In some example embodiments, the content module 310 is configured to detect a request by a computing device of a user to access content of an online service, such as content of the social networking system 210. For example, the content module 310 may detect the computing device navigating to a web page of the online service or the computing device opening a mobile application of the online service. Other types of requests to access content of the online service are also within the scope of the present disclosure.

In some example embodiments, the content module 310 is configured to identify at least one content item to display based on the request. A content item comprises any digital content that may be displayed within a user interface of a computing device. Examples of content items include, but are not limited to, an online news article (or a link to or other indication of the online news article), an online job posting (or a link to or other indication of the online job posting), and a profile status update of another user (or a link to or other indication of the profile status update of the other user).

In some example embodiments, the content module 310 is configured to, for each one of a plurality of candidate content items, generate a corresponding score based on a generalized linear mixed model, and then select the content item(s) based on the corresponding score(s) of the selected content item(s). The idea of the generalized linear mixed model approach employed by the content module 310 is to learn and use user-based models (or per-user models) based on the engagements of a particular user with content items, and item-based models (or per-item models) based on user engagements with a particular content item. In some example embodiments, the generalized linear mixed model is formulated as follows:

g(E(click|m,c))=w^{T}x_{mc}+αₘ^{T}x_{c}+β_{c}^{T}xₘ.

In the example embodiment of the generalized linear mixed model above, m the member (or user) index, c is the course index, and the first component w^{T}x_{mc} is the baseline model, which may be a logistic regression baseline. This baseline model is a generalized linear model based on the profile information of the target user and the metadata of the candidate content item. In some example embodiments, the baseline model is a fixed effects model that compares the profile information of the target user with the metadata of the candidate content item in order to determine similarity between the two. For example, for a target user whose profile information indicates that the target user is working as a software engineer, a candidate content item that has metadata indicating that the candidate content item is related to software engineering may be scored higher than a candidate content item that does not include metadata indicating that the candidate content item is related to software engineering but is rather related to a dissimilar topic such as playing the guitar.

In the example embodiment of the generalized linear mixed model above, the second component αₘ^{T}x_{c} is the user-based model, which is configured to boost the course categories of content items that the target user engaged with in the past. In the user-based model, x_{c} represents the subset of content item features with which the target user interacted. In some example embodiments, the user-based model is a random effects model based on a history of online activity by the target user directed towards reference content items having metadata determined to be related to the metadata of the candidate content item. For example, for a candidate content item having metadata indicating that the subject of the candidate content item is software engineering, the user-based model determines the level of interaction by the target user with content items that are determined to be related to the subject of software engineering, and assigns a higher score to the candidate content item as the level of interaction increases, such that the more often and/or to a higher degree that the target user interacted with (e.g., clicked on, viewed, etc.) content items that are related to software engineering, the higher the score the user-based model would assign to the candidate content item for that particular user.

In some example embodiments, the online activity directed towards the content items that is evaluated and considered by the user-based model is generating the score for the candidate content item comprises at least one of selecting a user interface element indicating an interest by the target user in consuming the reference content item. However, other types of online activity by the target user towards the content item are also within the scope of the present disclosure.

In the example embodiment of the generalized linear mixed model above, the last component β_{c}^{T}xₘ is the content-based model, which is configured to boost the titles of users who previously engaged with the content item. In some example embodiments, the content-based model is a random effects model based on a history of online activity directed towards the candidate content item by a plurality of reference users having profile information determined to be related to the profile information of the target user. For example, for a candidate content item, the content-based model determines the level of interaction by users that are determined to be sufficiently similar to the target user based on a comparison of their profile information, and assigns a higher score to the candidate content item as the level of interaction with that particular candidate content item for those similar users increases, such that the more often and/or to a higher degree that similar users interacted with (e.g., clicked on, viewed, etc.) that particular candidate content item, the higher the score the content-based model would assign to the candidate content item for the target user.

Other types of models besides the generalized linear mixed model discussed above may be used to score and select the content item(s) to display based on the request.

In some example embodiments, the presentation module 320 is configured to select a presentation template from amongst a plurality of presentation templates based on the content item(s) and an identification of the user. The plurality of presentation templates may stored in a database of the online service, such as the database(s) 340. In some example embodiments, each one of the plurality of presentation templates defines a corresponding manner in which to display the content item(s). For example, each presentation template may comprise a specification as to how elements of a content item are to be visually represented. Such elements may include, but are not limited to, an amount of text used to visually represent the content item, an amount of images used to visually represent the content item, an amount of video used to visually represent the content item, placement of elements of the content item on a display screen, which elements of the content item to display, and a size in which to display elements of the content item.

In some example embodiments, each presentation template in the plurality of presentation templates is distinct from one another with respect to at least one element. For example, a first presentation template and a second presentation template may differ only with respect to the text size that is to be used for any text of the content item, but they may otherwise be the same with respect to the other display elements. However, in some example embodiments, there are multiple differences between the different presentation templates in the plurality of presentation templates.

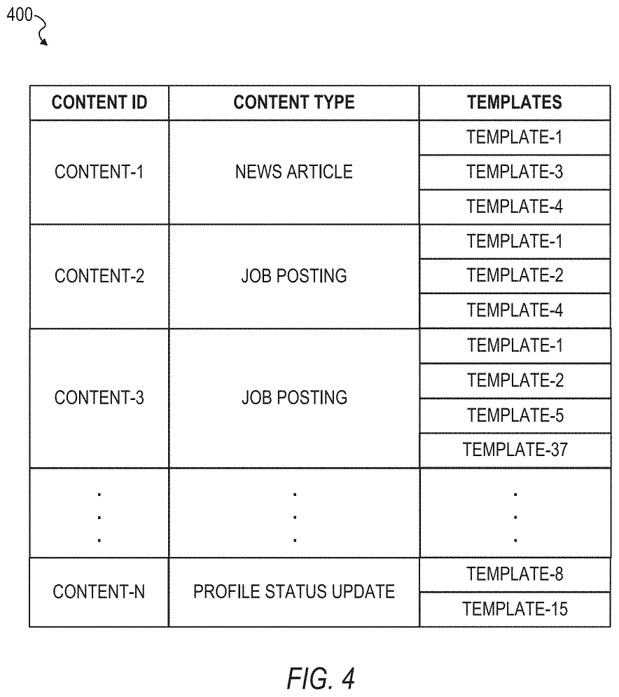

FIG. 4 illustrates a table 400 of presentation templates stored in a database, in accordance with an example embodiment. The table 400 includes indications of specific content items (e.g., CONTENT-1, CONTENT-2, . . . , CONTENT-N), content types of the content items (e.g., NEWS ARTICLE, JOB POSTING, PROFILE STATUS UPDATE), and presentation templates (e.g., TEMPLATE-1, TEMPLATE-2, . . . , TEMPLATE-N). As seen in the table 400, the presentation templates, or indications of the presentation templates, may be stored in association with specific content items, such that the presentation module 320 may look up the corresponding presentation templates associated with a particular content item, and then evaluate those corresponding presentation templates to select the appropriate presentation template for the particular content item that is to be displayed in the particular situation. For example, in determining which presentation template to use in displaying content item CONTENT-1, based on the stored associations between those presentation templates and the content item CONTENT-1 represented in table 400, the presentation module 320 identifies presentation templates TEMPLATE-1, TEMPLATE-3, and TEMPLATE-4 as the plurality of presentation templates from which to select the presentation template.

Additionally or alternatively, the presentation templates or indications of the presentation templates may be stored in association with specific content types (e.g., NEWS ARTICLE, JOB POSTING, PROFILE STATUS UPDATE), such that the presentation module 320 may look up the corresponding presentation templates associated with a particular type of content item, and then evaluate those corresponding presentation templates to select the appropriate presentation template for the particular type of content item that is to be displayed in the particular situation. It is contemplated that the same content type may have different sets of corresponding presentation templates depending on the specific content item at issue. For example, the table 400 in FIG. 4 shows content item CONTENT-2 and content item CONTENT-3 having overlapping yet different corresponding sets of presentation templates, despite the fact that both content item CONTENT-2 and content item CONTENT-3 being of the same content type, an online job posting, with content item CONTENT-2 having presentation templates TEMPLATE-1, TEMPLATE-2, and TEMPLATE-4, while content item CONTENT-3 has presentation templates TEMPLATE-1, TEMPLATE-2, TEMPLATE-5, and TEMPLATE-37.

In some example embodiments, the associations represented in the table 400 apply to a specific user, such that the associations between content items and presentation templates or between content types and presentation templates may be different for each user. For example, the same content item CONTENT-1 may have one set of presentation templates for one user and another different set of presentation templates for another user. Similarly, the same content type may have one set of presentation templates for one user and another different set of presentation templates for another user.

In some example embodiments, the presentation module 320 is configured to select the presentation template using a presentation model. The presentation model may be configured to generate corresponding scores for the plurality of presentation templates based on the content item, such as based on an identification of the content item or a content type of the content item, and the identification of the user. The score for each presentation template may be based on and indicate a predicted probability that the user will interact (e.g., view, click) with the content item when it is displayed in the specific manner defined by the presentation template. Other features may be incorporated into the presentation model to generate the corresponding scores for the presentation templates. The presentation model may be configured to select one of the presentation templates based on the generated scores, such as selecting the presentation template having the highest score.

In some example embodiments, the selecting of the presentation template is further based on one or more of the following factors that address the technical characteristics of the computing device of the user to whom the content item is to be displayed: a network connection strength of the computing device, a battery charge level of the computing device, a screen size of the computing device, a window size of a window in which the content item(s) is to be displayed on the computing device, a type of operating system of the computing device, a type of browser in which the content item(s) is to be displayed on the computing device, a device type of the computing device, and a font size for a browser in which the content item(s) is to be displayed on the computing device. Other factors on which the selecting of the presentation template may be based are also within the scope of the present disclosure.

In some example embodiments, the presentation module 320 is configured to cause the content item(s) to be displayed on the computing device in the corresponding manner of the selected presentation template. The content item(s) is displayed within a data feed of the user, such as within a data feed on a landing page for the user of the online service. However, the content item(s) may be displayed in other ways as well, including, but not limited to, within a page of a mobile application and within an electronic message (e.g., e-mail message, text message).

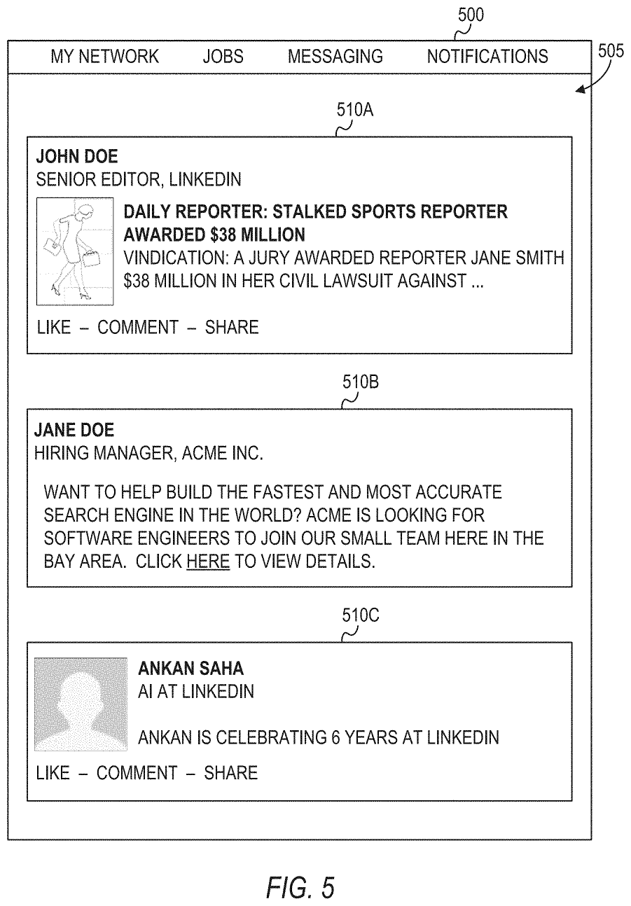

FIG. 5 illustrates a graphical user interface (GUI) 500 in which content items 510 are displayed using a presentation template, in accordance with an example embodiment. In the example shown in FIG. 5, three different types of content items 510A, 510B, and 510C are displayed within a data feed 505 on a landing page for the user of the online service. Content item 510A comprises an online news article, content item 510B comprises an online job posting, and content item 510C comprises a profile status update of another user of the online service. The presentation template for each content item 510 is selected based on the content item and the identification of the user to whom the content item 510 is to be presented.

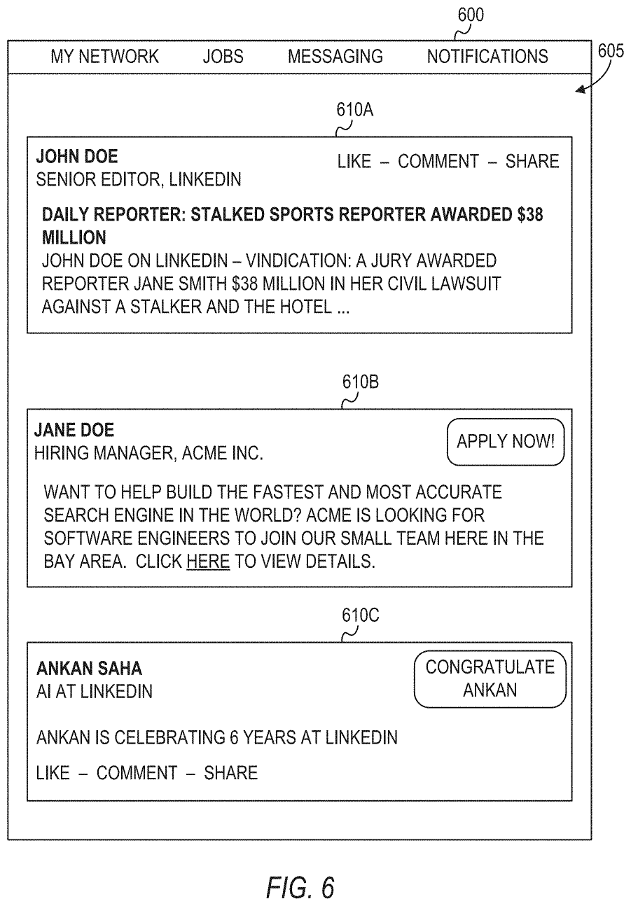

FIG. 6 illustrates a GUI 600 in which content items 610 are displayed using another presentation template, in accordance with an example embodiment. In the example shown in FIG. 6, three different types of content items 610A, 610B, and 610C are displayed within a data feed 605 on a landing page for another user of the online service. Content item 610A comprises an online news article, content item 610B comprises an online job posting, and content item 610C comprises a profile status update of yet another user of the online service. The presentation template for each content item 610 is selected based on the content item and the identification of the other user to whom the content item 610 is to be presented.

In some example embodiments, the content items 610 of FIG. 6 are the same as the content items 510 of FIG. 5, but they are displayed in different ways based on the fact that they are being displayed to different users. For example, content item 510A and content item 610A both comprise the same online news article. However, since the user for FIG. 6 is different from the user for FIG. 5, the presentation template used to display content item 610A is different from the presentation template used to display content item 510A, thereby resulting in content item 610A being visually represented in a different way than content item 510A.

For example, content item 510A includes an image associated with the online news article along with a title and text of the article, while content item 610A excludes any images and includes the title of the article along with more text of the article than shown for content item 510A. Additionally, the placement of social media action elements, such as selectable “LIKE,” “COMMENT,” and “SHARE” links are displayed in one position (bottom left) for content item 510A and in another position (top right) for content item 610A.

In another example, content item 510B includes a source and a description for an online job posting along with a selectable link to view more details of the online job posting, while content item 610B additionally includes a selectable “APPLY NOW!” button configured to enable the user to simply select the button to trigger an online application process for the online job posting.

In yet another example, content item 510C includes a text-based description of the profile status update of another user along with social media action elements, such as selectable “LIKE,” “COMMENT,” and “SHARE” links. Content item 610C additionally includes a selectable “CONGRATULATE” button configured to enable the user to simply select the button to trigger an online process where the user can enter a congratulatory message to be transmitted to the other user or to trigger the transmission of an automatic congratulatory message to the other user.

In some example embodiments, the machine learning module 330 is configured to receive behavioral data indicating a response of the user to the display of the content item(s) on the computing device. The behavioral data may comprise at least one of an indication of an amount of time during which the content item(s) was visible on a screen of the computing device (e.g., did the user scroll right by the content item or did the user look at the content item for a significant amount of time), an indication of an amount of the content item(s) visible on the screen of the computing device (e.g., only one-tenth of the content item being visible on the screen versus the entire content item being visible on the screen), and an indication of the user clicking on a link corresponding to the content item(s). Other types of behavioural data are also within the scope of the present disclosure.

In some example embodiments, the machine learning module 330 is configured to use the behavioral data as training data in at least one machine learning operation to train the presentation model. For example, one or more weights of features of the presentation model may be modified using the behavioural data as training data in the machine learning operation(s). in this respect, the presentation model is personalized for the user by taking into account that the user has responded positively to certain ways of presenting content items and has responded negatively to other ways of presenting content items. Other ways of using the behavioural data to train the presentation model are also within the scope of the present disclosure.

In some example embodiments, the machine learning module 330 is configured to use the behavioral data as training data in at least one machine learning operation to train a generation model. The generation model is configured to generate an additional presentation template. The machine learning operation(s) may cause the generation model to learn and recognize display characteristic preferences of users that can be used to generate new presentation templates.

In some example embodiments, the machine learning module 330 is configured to generate another presentation template that is distinct from the other presentation templates using the trained generation model. The machine learning module 330 may then store this newly-generated presentation template as part of the plurality of presentation templates in the database 340 of the online service for subsequent use by the presentation module 320 in selecting a presentation template. For example, the other presentation template may be incorporated into the table 400 in FIG. 4, where it may be stored in association with specific content items and/or content types.

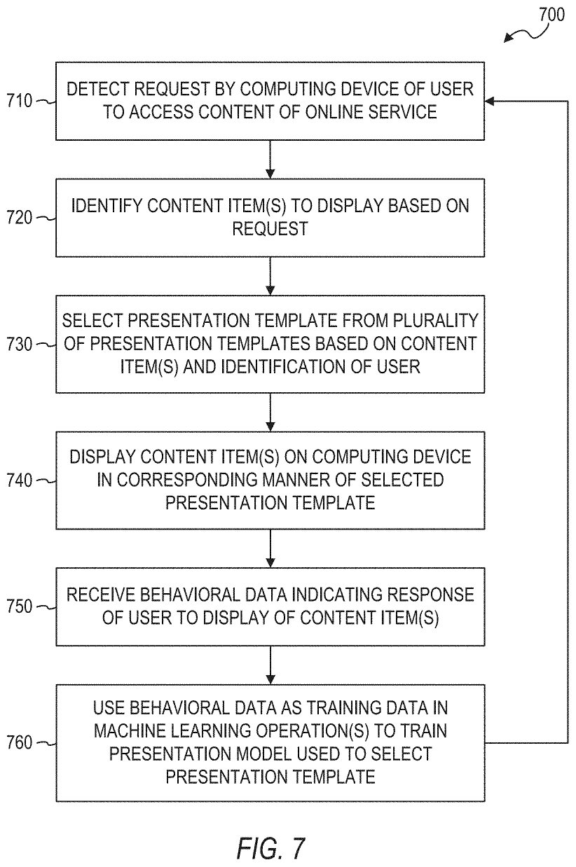

FIG. 7 is a flowchart illustrating a method of personalizing a user experience for a user of an online service, in accordance with an example embodiment. The method 700 can be performed by processing logic that can comprise hardware (e.g., circuitry, dedicated logic, programmable logic, microcode, etc.), software (e.g., instructions run on a processing device), or a combination thereof. In one implementation, the method 700 is performed by the user experience system 216 of FIGS. 2-3, or any combination of one or more of its modules (e.g., the content module 310, the presentation module 320, the machine learning module 330), as described above.

At operation 710, the user experience system 216 detects a request by a computing device of a user to access content of an online service. For example, the user experience system 216 may detect the computing device navigating to a web page of the online service or the computing device opening a mobile application of the online service. Other types of requests to access content of the online service are also within the scope of the present disclosure.

At operation 720, the user experience system 216 identifies at least one content item to display based on the request. In some example embodiments, the user experience system 216 is configured to, for each one of the plurality of candidate content items, generate a corresponding score based on a generalized linear mixed model, and then select the content item(s) based on the corresponding score(s) of the selected content item(s). Other types of models may be used to score and select the content item(s) to display based on the request.

At operation 730, the user experience system 216 selects a presentation template from amongst a plurality of presentation templates based on the content item(s) and an identification of the user. In some example embodiments, the plurality of presentation templates is stored in a database of the online service, with each one of the plurality of presentation templates being distinct from one another and defining a corresponding manner in which to display the content item(s).

The user experience system 216 may select the presentation template using a presentation model. The presentation model may be configured to generate corresponding scores for the plurality of presentation templates based on the content item(s) and the identification of the user. Other features may be incorporated into the presentation model to generate the corresponding scores for the presentation templates. The presentation model may be configured to select one of the presentation templates based on the generated scores, such as selecting the presentation template having the highest score.

In some example embodiments, the corresponding presentation templates of at least two of the plurality of presentation templates differ in one or more of the following ways: an amount of text used to visually represent the content item(s), an amount of images used to visually represent the content item(s), an amount of video used to visually represent the content item(s), placement of elements of the content item(s) on a display screen, which elements of the content item(s) to display, and a size in which to display elements of the content item(s). Other ways in which the presentation templates differ are also within the scope of the present disclosure.

In some example embodiments, the selecting of the presentation template is further based on one or more of the following factors: a network connection strength of the computing device, a battery charge level of the computing device, a screen size of the computing device, a window size of a window in which the content item(s) is to be displayed on the computing device, a type of operating system of the computing device, a type of browser in which the content item(s) is to be displayed on the computing device, a device type of the computing device, and a font size for a browser in which the content item(s) is to be displayed on the computing device. Other factors on which the selecting of the presentation template may be based are also within the scope of the present disclosure.

At operation 740, the user experience system 216 causes the content item(s) to be displayed on the computing device in the corresponding manner of the selected presentation template. In some example embodiments, the content item(s) is displayed within a data feed of the user, such as within a data feed on a landing page for the user of the online service. The content item(s) may be displayed in other ways as well.

At operation 750, the user experience system 216 receives behavioral data indicating a response of the user to the display of the content item(s) on the computing device. In some example embodiments, the behavioral data comprises at least one of an indication of an amount of time during which the content item(s) was visible on a screen of the computing device, an indication of an amount of the content item(s) visible on the screen of the computing device, and an indication of the user clicking on a link corresponding to the content item(s). Other types of behavioural data are also within the scope of the present disclosure.

At operation 760, the user experience system 216 uses the behavioral data as training data in at least one machine learning operation to train the presentation model. For example, one or more weights of features of the presentation model may be modified using the behavioural data as training data in the machine learning operation(s). Other ways of using the behavioural data to train the presentation model are also within the scope of the present disclosure.

The method 700 may then return to operation 710, where the user experience system 216 may detect another request by the computing device of the user to access content of the online service or another request by another computing device of another user to access content.

It is contemplated that any of the other features described within the present disclosure can be incorporated into the method 700.

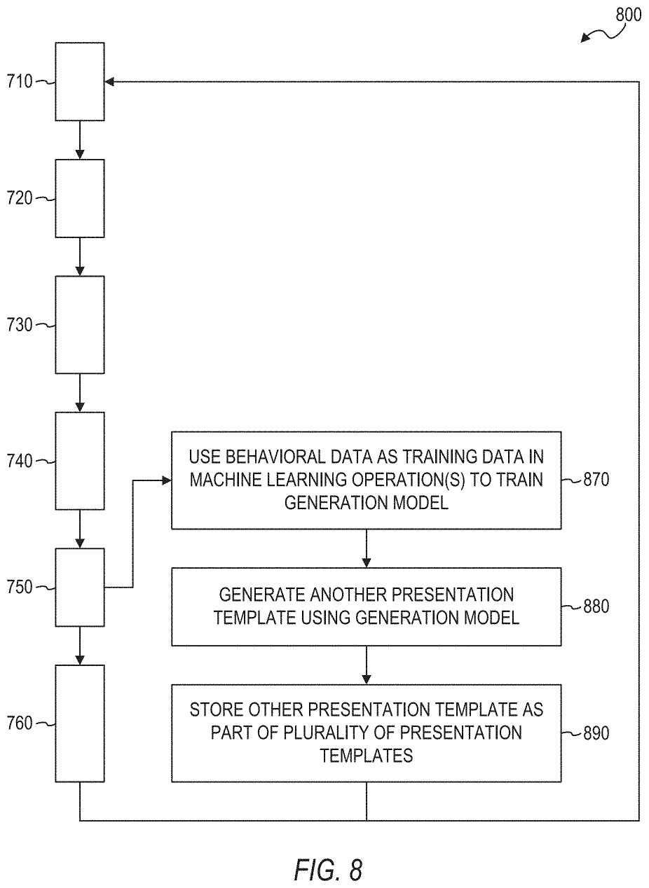

FIG. 8 is a flowchart illustrating another method of personalizing a user experience for a user of an online service. The method 800 can be performed by processing logic that can comprise hardware (e.g., circuitry, dedicated logic, programmable logic, microcode, etc.), software (e.g., instructions run on a processing device), or a combination thereof. In one implementation, the method 800 is performed by the user experience system 216 of FIGS. 2-3, or any combination of one or more of its modules (e.g., the content module 310, the presentation module 320, the machine learning module 330), as described above. In some example embodiments, the method 800 comprises operations 870, 880, and 890, which are performed subsequent to the performance of operation 750 of the method 700 in FIG. 7.

At operation 870, the user experience system 216 uses the behavioral data received at operation 750 as training data in at least one machine learning operation to train a generation model to generate an additional presentation template. The machine learning operation(s) cause the generation model to learn and recognize display characteristic preferences of users that can be used to generate new presentation templates.

At operation 880, the user experience system 216 generates another presentation template using the trained generation model. In some example embodiments, the other presentation template is distinct from the plurality of presentation templates and defines a corresponding manner in which to display the content item(s). The other presentation template may differ from the plurality of presentation templates by one or more aspects, including, but not limited to, an amount of text used to visually represent content items, an amount of images used to visually represent content items, an amount of video used to visually represent content items, placement of elements of the content items on a display screen, which elements of the content items to display, and a size in which to display elements of the content items.

At operation 890, the user experience system 216 stores the other presentation template as part of the plurality of presentation templates in the database of the online service. For example, the other presentation template may be incorporated into the table 400 in FIG. 4, where it may be stored in association with specific content items and/or content types.

The method 800 may then return to operation 710, where the user experience system 216 may detect another request by the computing device of the user to access content of the online service or another request by another computing device of another user to access content.

It is contemplated that any of the other features described within the present disclosure can be incorporated into the method 800.

The user experience system 216 personally tailors each component of which a content item can be composed to be visually represented in a way that a viewing user will be most engaged with. As an example, certain presentation templates can be larger and more visually appealing for users who are more influenced by visuals, whereas for users that are more content-focused, the user experience system 216 may show a smaller and more text-heavy representation that will allow for the same engagement but also enable more content from other content items to show on the screen. The user experience system 216 may learn and understand which presentation templates each user prefers and engages with the most.

In addition to changing the styling of content items, the user experience system 216 can be used to dynamically construct the order in which components of a content item are organized to represent the content item. As an example, the user experience system 216 may adjust the ordering of the text, images, and other components of the content item depending on the user to whom the content item is to be displayed. For example, the user experience system 216 can move a highlighted comment component to the top of a content item that comprises a profile status update of another user in order to emphasize the conversation between the user and the other user. In another example, the user experience system 216 may represent aggregated content items as a carousel instead of a list and vice-versa depending on the user to whom they are to be displayed.

In some example embodiments, for each update that is shown within a user's feed, the user experience system 216 develops an understanding of the propensity a user has for performing a certain action on that update (e.g., like, comment, share, follow, connect, message) based on collected behavioral data indicating how the user has responded to the display of updates in the past. The user experience system 216 may personalize the manner in which a content item is displayed, adapting the visual representation of these updates to encourage certain user actions that are most beneficial to them and the rest of the content ecosystem. As an example, if a user is likely to interact with other pieces of content that the author of the update the user is viewing, then the user experience system 216 may emphasize the follow button on the user interface to encourage the user to follow. If a user's connections or followers are likely to also engage with this piece of content, then the user experience system 216 may encourage the user to like, comment, or share so that the viral content gets distributed to this user's network.

After a user engages with a content item, it provides an opportunity to adapt the presentation of content to elicit further engagement. As an example, after a user reads an article, the user experience system 216 can adapt the user interface in certain ways, including, but not limited to, displaying a connect button if the user is likely to know the author, displaying a follow button if the user is likely to follow and engage with more of this author's content, and encourage the user to submit a comment via selectable comment links to add to the discussion or reshare if the user is a top contributor within the content space of the article.

In some example embodiments, the user experience system 216 is configured to run permutations on all many different factors to create a presentation that is most engaging to a user and that is most technically efficient and effective with respect to the technical characteristics of the computing device of the user. Such factors may include, but are not limited to, pixel changes between elements, color of selectable button, size of selectable buttons, text fonts, and ordering of information.

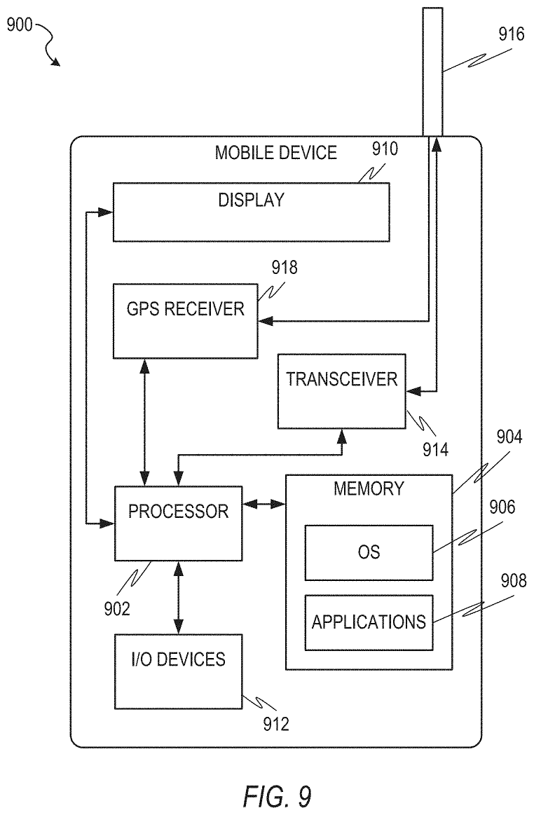

FIG. 9 is a block diagram illustrating a mobile device 900, according to an example embodiment. The mobile device 900 can include a processor 902. The processor 902 can be any of a variety of different types of commercially available processors suitable for mobile devices 900 (for example, an XScale architecture microprocessor, a Microprocessor without Interlocked Pipeline Stages (MIPS) architecture processor, or another type of processor). A memory 904, such as a random access memory (RAM), a Flash memory, or other type of memory, is typically accessible to the processor 902. The memory 904 can be adapted to store an operating system (OS) 906, as well as application programs 908, such as a mobile location-enabled application that can provide location-based services (LBSs) to a user. The processor 902 can be coupled, either directly or via appropriate intermediary hardware, to a display 910 and to one or more input/output (I/O) devices 912, such as a keypad, a touch panel sensor, a microphone, and the like. Similarly, in some embodiments, the processor 902 can be coupled to a transceiver 914 that interfaces with an antenna 916. The transceiver 914 can be configured to both transmit and receive cellular network signals, wireless data signals, or other types of signals via the antenna 916, depending on the nature of the mobile device 900. Further, in some configurations, a GPS receiver 918 can also make use of the antenna 916 to receive GPS signals.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a processor configured using software, the processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

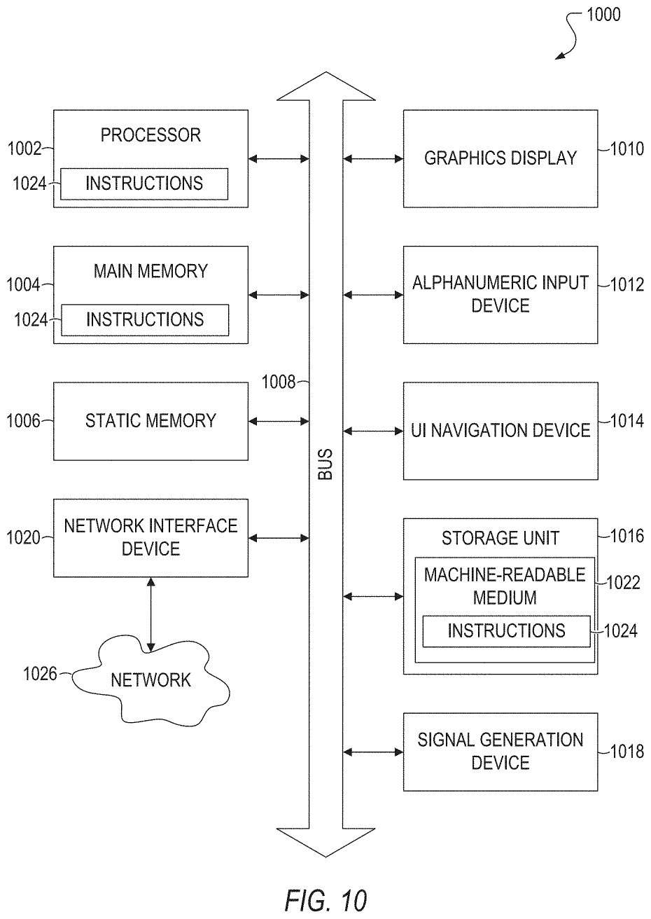

FIG. 10 is a block diagram of an example computer system 1000 on which methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a graphics display unit 1010 (e.g., a liquid crystal display (LCD) or a cathode ray tube (CRT)). The computer system 1000 also includes an alphanumeric input device 1012 (e.g., a keyboard or a touch-sensitive display screen), a user interface (UI) navigation device 1014 (e.g., a mouse), a storage unit 1016, a signal generation device 1018 (e.g., a speaker) and a network interface device 1020.

The storage unit 1016 includes a machine-readable medium 1022 on which is stored one or more sets of instructions and data structures (e.g., software) 1024 embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media.

While the machine-readable medium 1022 is shown in an example embodiment to be a single medium, the term “machine-readable medium” may include a single medium or multiple media (e.g., a centralized or distributed database, and/or associated caches and servers) that store the one or more instructions 1024 or data structures. The term “machine-readable medium” shall also be taken to include any tangible medium that is capable of storing, encoding or carrying instructions (e.g., instructions 1024) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

The following numbered examples are embodiments.
1. A computer-implemented method comprising:
   detecting, by a computer system having a memory and at least one hardware processor, a first request by a first computing device of a first user to access content of an online service;
   identifying, by the computer system, at least one content item to display based on the first request;
   selecting, by the computer system, a first presentation template from amongst a plurality of presentation templates based on the at least one content item and an identification of the first user, the plurality of presentation templates being stored in a database of the online service, each one of the plurality of presentation templates being distinct from one another and defining a corresponding manner in which to display the at least one content item; and
   causing, by the computer system, the at least one content item to be displayed on the first computing device in the corresponding manner of the selected first presentation template.
2. The computer-implemented method of example 1, wherein the selecting the first presentation template is performed using a presentation model, and the computer-implemented method further comprises:
   receiving, by the computer system, first behavioral data indicating a first response of the first user to the display of the at least one content item on the first computing device; and
   using, by the computer system, the first behavioral data as training data in at least one machine learning operation to train the presentation model.
3. The computer-implemented method of example 1 or example 2, wherein the first behavioral data comprises at least one of an indication of an amount of time during which the at least one content item was visible on a screen of the first computing device, an indication of an amount of the at least one content item visible on the screen of the first computing device, and an indication of the first user clicking on a link corresponding to the at least one content item.
4. The computer-implemented method of any one of examples 1 to 3, wherein the corresponding presentation templates of at least two of the plurality of presentation templates differ in an amount of text used to visually represent the at least one content item.
5. The computer-implemented method of any one of examples 1 to 4, wherein the corresponding presentation templates of at least two of the plurality of presentation templates differ in an amount of images used to visually represent the at least one content item.
6. The computer-implemented method of any one of examples 1 to 5, wherein the corresponding presentation templates of at least two of the plurality of presentation templates differ in an amount of video used to visually represent the at least one content item.
7. The computer-implemented method of any one of examples 1 to 6, wherein the corresponding presentation templates of at least two of the plurality of presentation templates differ in placement of elements of the at least one content item on a display screen.
8. The computer-implemented method of any one of examples 1 to 7, wherein the corresponding presentation templates of at least two of the plurality of presentation templates differ in which elements of the at least one content item to display.
9. The computer-implemented method of any one of examples 1 to 8, wherein the corresponding presentation templates of at least two of the plurality of presentation templates differ in a size in which to display elements of the at least one content item.
10. The computer-implemented method of any one of examples 1 to 9, wherein the selecting of the first presentation template is further based on a network connection strength of the first computing device.
11. The computer-implemented method of any one of examples 1 to 10, wherein the selecting of the first presentation template is further based on a battery charge level of the first computing device.
12. The computer-implemented method of any one of examples 1 to 11, wherein the selecting of the first presentation template is further based on at least one of a screen size of the first computing device and a window size of a window in which the at least one content item is to be displayed on the first computing device.
13. The computer-implemented method of any one of examples 1 to 12, wherein the selecting of the first presentation template is further based on at least one of a type of operating system of the first computing device and a type of browser in which the at least one content item is to be displayed on the first computing device.
14. The computer-implemented method of any one of examples 1 to 13, wherein the selecting of the first presentation template is further based on a device type of the first computing device.
15. The computer-implemented method of any one of examples 1 to 14, wherein the selecting of the first presentation template is further based on a font size for a browser in which the at least one content item is to be displayed on the first computing device.
16. The computer-implemented method of any one of examples 1 to 15, further comprising:
   detecting, by the computer system, a second request by a second computing device of a second user to access content of the online service;
   identifying, by the computer system, the at least one content item to display based on the second request;
   selecting, by the computer system, a second presentation template from amongst the plurality of presentation templates based on the at least one content item and an identification of the second user; and
   causing, by the computer system, the at least one content item to be displayed on the second computing device in the corresponding manner of the selected second presentation template.
17. The computer-implemented method of any one of examples 1 to 16, further comprising:
   receiving, by the computer system, first behavioral data indicating a first response of the first user to the display of the at least one content item on the first computing device;
   using, by the computer system, the first behavioral data as training data in at least one machine learning operation to train a generation model;
   generating, by the computer system, another presentation template using the trained generation model, the other presentation template being distinct from the plurality of presentation templates and defining a corresponding manner in which to display the at least one content item; and
   storing, by the computer system, the other presentation template as part of the plurality of presentation templates in the database of the online service.
18. The computer-implemented method of any one of examples 1 to 17, further comprising:
   detecting, by a computer system having a memory and at least one hardware processor, a second request by the first computing device of the first user to access content of an online service;
   identifying, by the computer system, at least one other content item to display based on the second request;
   selecting, by the computer system, the other presentation template from amongst the plurality of presentation templates based on the at least one other content item and the identification of the first user; and
   causing, by the computer system, the at least one other content item to be displayed on the first computing device in the corresponding manner of the selected other presentation template.
19. A system comprising:
   at least one processor; and
   a non-transitory computer-readable medium storing executable instructions that, when executed, cause the at least one processor to perform the method of any one of examples 1 to 18.
20. A non-transitory machine-readable storage medium, tangibly embodying a set of instructions that, when executed by at least one processor, causes the at least one processor to perform the method of any one of examples 1 to 18.
21. A machine-readable medium carrying a set of instructions that, when executed by at least one processor, causes the at least one processor to carry out the method of any one of examples 1 to 18.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
detecting, by a computer system having a memory and at least one hardware processor, a first request by a first computing device of a first user to access content of an online service;
identifying, by the computer system, at least one content item to display based on the first request;
selecting, by the computer system, a first presentation template from amongst a plurality of presentation templates based on the at least one content item and an identification of the first user, the plurality of presentation templates being stored in a database of the online service, each one of the plurality of presentation templates being distinct from one another and defining a corresponding manner in which to display the at least one content item; and
causing, by the computer system, the at least one content item to be displayed on the first computing device in the corresponding manner of the selected first presentation template.

2. The computer-implemented method of claim 1, wherein the selecting the first presentation template is performed using a presentation model, and the computer-implemented method further comprises:
receiving, by the computer system, first behavioral data indicating a first response of the first user to the display of the at least one content item on the first computing device; and
using, by the computer system, the first behavioral data as training data in at least one machine learning operation to train the presentation model.

3. The computer-implemented method of claim 2, wherein the first behavioral data comprises at least one of an indication of an amount of time during which the at least one content item was visible on a screen of the first computing device, an indication of an amount of the at least one content item visible on the screen of the first computing device, and an indication of the first user clicking on a link corresponding to the at least one content item.

4. The computer-implemented method of claim 1, wherein the corresponding presentation templates of at least two of the plurality of presentation templates differ in an amount of text used to visually represent the at least one content item.

5. The computer-implemented method of claim 1, wherein the corresponding presentation templates of at least two of the plurality of presentation templates differ in an amount of images used to visually represent the at least one content item.

6. The computer-implemented method of claim 1, wherein the corresponding presentation templates of at least two of the plurality of presentation templates differ in an amount of video used to visually represent the at least one content item.

7. The computer-implemented method of claim 1, wherein the corresponding presentation templates of at least two of the plurality of presentation templates differ in placement of elements of the at least one content item on a display screen.

8. The computer-implemented method of claim 1, wherein the corresponding presentation templates of at least two of the plurality of presentation templates differ in which elements of the at least one content item to display.

9. The computer-implemented method of claim 1, wherein the corresponding presentation templates of at least two of the plurality of presentation templates differ in a size in which to display elements of the at least one content item.

10. The computer-implemented method of claim 1, wherein the selecting of the first presentation template is further based on a network connection strength of the first computing device.

11. The computer-implemented method of claim 1, wherein the selecting of the first presentation template is further based on a battery charge level of the first computing device.

12. The computer-implemented method of claim 1, wherein the selecting of the first presentation template is further based on at least one of a screen size of the first computing device and a window size of a window in which the at least one content item is to be displayed on the first computing device.

13. The computer-implemented method of claim 1, wherein the selecting of the first presentation template is further based on at least one of a type of operating system of the first computing device and a type of browser in which the at least one content item is to be displayed on the first computing device.

14. The computer-implemented method of claim 1, wherein the selecting of the first presentation template is further based on a device type of the first computing device.

15. The computer-implemented method of claim 1, wherein the selecting of the first presentation template is further based on a font size for a browser in which the at least one content item is to be displayed on the first computing device.

16. The computer-implemented method of claim 1, further comprising:
detecting, by the computer system, a second request by a second computing device of a second user to access content of the online service;
identifying, by the computer system, the at least one content item to display based on the second request;
selecting, by the computer system, a second presentation template from amongst the plurality of presentation templates based on the at least one content item and an identification of the second user; and
causing, by the computer system, the at least one content item to be displayed on the second computing device in the corresponding manner of the selected second presentation template.

17. The computer-implemented method of claim 1, further comprising:
receiving, by the computer system, first behavioral data indicating a first response of the first user to the display of the at least one content item on the first computing device;
using, by the computer system, the first behavioral data as training data in at least one machine learning operation to train a generation model;
generating, by the computer system, another presentation template using the trained generation model, the other presentation template being distinct from the plurality of presentation templates and defining a corresponding manner in which to display the at least one content item; and
storing, by the computer system, the other presentation template as part of the plurality of presentation templates in the database of the online service.

18. The computer-implemented method of claim 17, further comprising:
detecting, by a computer system having a memory and at least one hardware processor, a second request by the first computing device of the first user to access content of an online service;
identifying, by the computer system, at least one other content item to display based on the second request;
selecting, by the computer system, the other presentation template from amongst the plurality of presentation templates based on the at least one other content item and the identification of the first user; and
causing, by the computer system, the at least one other content item to be displayed on the first computing device in the corresponding manner of the selected other presentation template.

19. A system comprising:
at least one hardware processor; and
a non-transitory machine-readable medium embodying a set of instructions that, when executed by the at least one hardware processor, cause the at least one processor to perform operations, the operations comprising:
detecting a first request by a first computing device of a first user to access content of an online service;
identifying at least one content item to display based on the first request;
selecting a first presentation template from amongst a plurality of presentation templates based on the at least one content item and an identification of the first user, the plurality of presentation templates being stored in a database of the online service, each one of the plurality of presentation templates being distinct from one another and defining a corresponding manner in which to display the at least one content item; and
causing the at least one content item to be displayed on the first computing device in the corresponding manner of the selected first presentation template.

20. A non-transitory machine-readable medium embodying a set of instructions that, when executed by at least one hardware processor, cause the processor to perform operations, the operations comprising:
detecting a first request by a first computing device of a first user to access content of an online service;
identifying at least one content item to display based on the first request;
selecting a first presentation template from amongst a plurality of presentation templates based on the at least one content item and an identification of the first user, the plurality of presentation templates being stored in a database of the online service, each one of the plurality of presentation templates being distinct from one another and defining a corresponding manner in which to display the at least one content item; and
causing the at least one content item to be displayed on the first computing device in the corresponding manner of the selected first presentation template.
